(19) United States
(12) Patent Application Publication
(10) Pub. No.: US 2008/0299910 A1
(43) Pub. Date: Dec. 4, 2008

(54) Method and system for measuring cross technology wireless coverage

(75) Inventors: David Petersen, San Francisco, CA (US); Padraig Stapleton, Pleasanton, CA (US)

Correspondence Address: HANLEY, FLIGHT & ZIMMERMAN, LLC, 150 S. WACKER DRIVE, SUITE 2100, CHICAGO, IL, 60606, US

(73) Assignee: TELEPHIA INCORPORATION, SAN FRANCISCO, CA (US)

(21) Appl. No.: 11/809,318

(22) Filed: May 30, 2007

(51) Int. Cl. H04B 17/00; H04Q 7/20

(52) U.S. Cl. 455/67.11; 455/446; 455/67.7

(57) ABSTRACT

A method of measuring wireless cross technology wireless coverage. The method includes initiating a call from a wireless device using a given wireless technology; in response to the initiating, receiving a plurality of data for the given wireless technology; in response to the receiving, analyzing the plurality of data; repeating the above steps for various wireless technologies; and generating a calibration for the analysis of the plurality of data for various wireless technologies. The adjusted data in response to the generated calibration is constructed and outputted. In one embodiment, the analysis includes determining the signal strength for the wireless device of the given wireless technology and determining the probability of call failure for the wireless device of the given wireless technology. Accordingly, at a given probability of call failure, signal strengths of the wireless device for various wireless technologies are corresponded and are equivalent to one another.

### TECHNICAL FIELD

The present invention relates to the field of wireless communication systems. More particularly, embodiments of the present invention relate to a method and system for measuring cross technology wireless coverage.

### BACKGROUND ART

Increase in use of wireless devices over the past few years has led to development of various technologies and standards. For example, time division multiple access (TDMA), code division multiple access (CDMA), wideband code division multiple access (WCDMA), worldwide interoperability for microwave access (WIMAX), and global system for mobile communication (GSM) are only a few of the technologies that have been developed and used in recent years.

In general, each wireless provider uses a specific technology (e.g., CDMA, TDMA, WIMAX, GSM, and etc.) for providing wireless services to their subscribers. Information regarding the performance of the technology (e.g., coverage) implemented by the provider is invaluable. For example, each provider may be interested in information regarding their coverage, their signal strength, the probability of call failure, the number of blocked calls, and the quality of the connection. In fact, information regarding the coverage of a wireless technology is invaluable because it can be used to improve the performance and the coverage which in itself is invaluable given the rapid increase in wireless technologies and increase in their demand.

Entities such as the IEEE organization publish various articles and information regarding different standards. For example, IEEE provides information regarding the signal strength for CDMA technology and may indicate that a signal strength below −110 dB results in a poor quality connection or that it may result in a call failure. Currently wireless providers use information published by IEEE and similar organizations to determine their signal strength, their signal quality, the number of blocked calls, the number of failed calls, and their coverage in general.

Unfortunately, IEEE and similar entities fail to provide a complete picture and compare the coverage of various wireless technologies together. For example, currently there is little or no information comparing the coverage of different wireless technologies, hence the same signal strength for different wireless technologies may result in a different number of call failure (e.g., a given signal strength for a CDMA and a TDMA may result in probability of call failure of 30% and 32% respectively). In other words, there is currently no unique standard where the coverage of different wireless technologies can be compared.

### SUMMARY

Accordingly, a need has risen to provide a unique standard wherein performance and coverage of different wireless technologies can be compared. More particularly, a need has risen to provide a standardized information regarding the comparison of coverage between various wireless technologies such that equivalent signal strength for different technologies can be found given a probability of call failure. It will become apparent to those skilled in the art after reading the detailed description of the present invention that the embodiments of the present invention satisfy the above mentioned needs.

In one embodiment, a wireless test equipment initiates a call from a wireless cellular structure to a cellular tower. The wireless test equipment then receives a plurality of data that may be analyzed in order to determine information such as the signal strength, the probability of call failure, and the signal quality, to name a few. The process described may be repeated using different wireless technologies and at different cellular structures in order to obtain a statistically large enough sample to represent the entire wireless cellular market. When the received data is analyzed, the signal levels for each wireless technology may be calibrated. For example, to calibrate signal levels for two wireless technologies, their respective signal strength at a given probability of call failure may be compared (e.g., at probability of call failure of 30%, the signal strength of technology A may be compared to the signal strength of technology B). Upon generating the calibration of signal levels, the signals may be adjusted such that the signal strength of technology A in the above example equates to the signal strength of technology B at probability of call failure of 30%. In one embodiment the result of the adjusted signal may be displayed as a table, a graph, or other relevant format. The output may also be provided in an audio format. In another embodiment, the result may be output to other electronic devices such that various parameters for a given technology in a given cellular structure can be changed to vary its performance and its coverage.

As a result of employing the embodiments of the present invention, the coverage of wireless providers using various wireless technologies may be accurately compared. More specifically, employing the embodiments of the present invention, the signal strength of various wireless technologies for a given probability of call failure may be equated. As such, the signal strengths, corresponding to the probability of call failures for various wireless technologies, may be interpreted to be the equivalent.

One embodiment of the present invention pertains to a method of measuring cross technology wireless coverage, said method includes a) initiating a call from a wireless device using a given wireless technology; b) in response to the initiating, receiving a plurality of data for the given wireless technology; c) in response to the receiving, analyzing the plurality of data; d) repeating steps (a)-(c) for various wireless technologies; and e) generating a calibration for the analysis of the plurality of data for various wireless technologies.

Embodiments include the above and wherein the method further includes f) constructing adjusted data for the plurality of data in response to the generated calibration. Moreover, the embodiments further include the above and wherein the method further includes (g) outputting the constructed adjusted data. In one embodiment, the constructed adjusted data is visually outputted. In another embodiment, the constructed adjusted data may be outputted in audio format.

Moreover, the embodiments further include the above and wherein the analyzing includes determining the signal strength for the wireless device of the given wireless technology; and determining the probability of call failures for the wireless device of the given wireless technology. Furthermore, the embodiments include the above and wherein the calibration includes: at a given probability of call failure, corresponding signal strengths of the wireless device for various wireless technologies to one another.

### BRIEF DESCRIPTION OF THE DRAWINGS

FIG. 1 shows a flow diagram of a computer implemented process for measuring cross technology wireless coverage in accordance with one embodiment of the present invention.

FIG. 2 shows one system embodiment for gathering and receiving data in accordance with one embodiment of the present invention.

FIG. 3 shows an exemplary analysis of received voice data in accordance with one embodiment of the present invention.

FIG. 4 shows an exemplary calibration of analyzed voice data in accordance with one embodiment of the present invention.

FIG. 5 shows an exemplary adjusted signal levels in accordance with one embodiment of the present invention.

FIG. 6 shows an exemplary calibration of analyzed data in accordance with one embodiment of the present invention.

FIG. 7 illustrates a general purpose computer system that may serve as a platform for receiving and gathering data in accordance with embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternative, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one ordinary skill in the art that the present invention may be practiced without these specific details. In other instances, well known methods, procedures, components, and circuits have not been described in detail as not to unnecessarily obscure aspects of the invention.

Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from following discussions, it is appreciated that throughout the present invention, discussions utilizing terms such as “processing” or “creating” or “transferring” or “executing” or “determining” or “instructing” or “issuing” or “halting” or “clearing” or “accessing” or “aggregating” or “obtaining” or “selecting” or “initiating” or “receiving” or “analyzing” or “generating” or “constructing” or “outputting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### A Method and System for Measuring Cross Technology Wireless Coverage

Measuring cross technology wireless coverage provides a mean for accurately comparing coverage of various wireless technologies. The term “coverage” used throughout this document refers to signal strength and whether the signal strength is strong enough for a call to be initiated. Parameters used to determine the coverage for a given wireless technology includes but is not limited to the signal strength and the probability of call failure, to name a few. Since different wireless technologies use different techniques, the same signal strength results in different probability of call failure and a different signal quality. The method and system in accordance with the embodiments of the present invention provide a mean such that coverage and performance for various wireless technologies can be accurately compared and standardized.

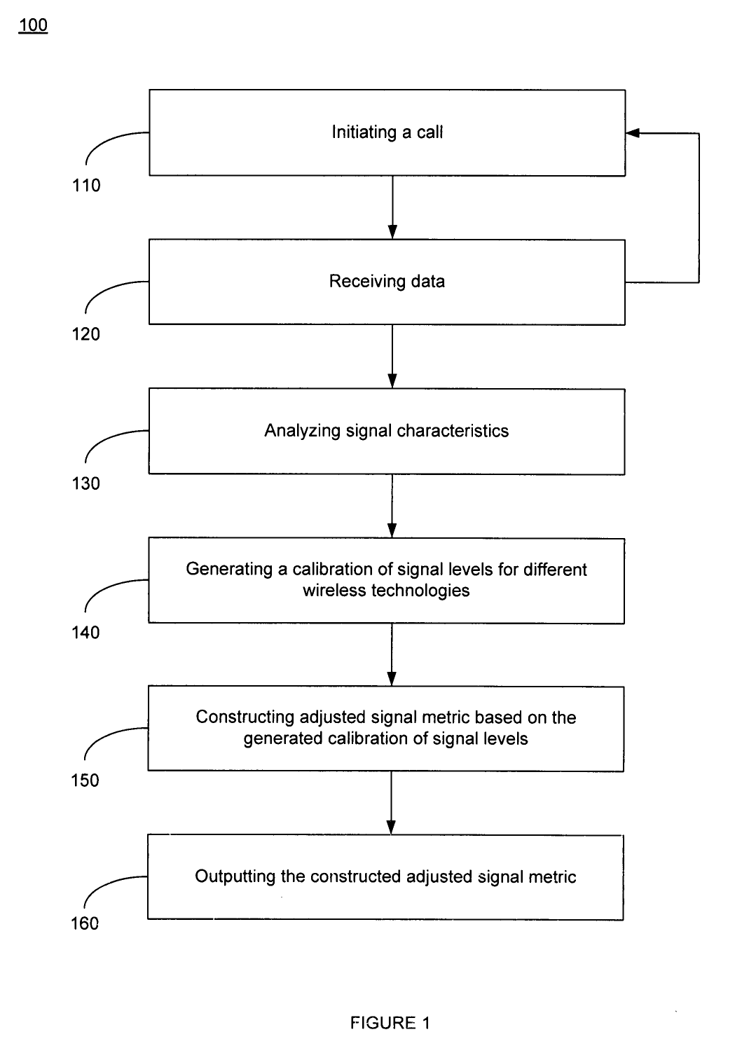

Referring now to FIG. 1, a flow diagram 100 for measuring cross technology wireless coverage in accordance with one embodiment of the present invention is shown. At step 110, a call may be initiated by a wireless test equipment. In one embodiment, the wireless test equipment initiating the call may be a wireless device capable of communicating with another device.

In general, to initiate a call two channels are used. The first channel is referred to as the control channel (e.g., in a CDMA system the control channel is referred to as the pilot channel). The second channel is referred to as the traffic channel. In order for a wireless device to contact another device, a call is initiated on the control channel. The control channel is used to initiate and establish a connection between the wireless device and another device (e.g., a landline telephone). Upon establishing the connection, data transfer is initiated on the traffic channel. In general, the signal strength at the control channel is stronger because the base station and the wireless device are seeking to locate one another in order to establish a connection for initiating a data transfer over the traffic channel.

Accordingly, in one embodiment of the present invention, the wireless test equipment may comprise of a plurality of cellular phones that use various technologies (e.g., CDMA, TDMA, WCDMA, GSM, WIMAX, and etc.) and at least one scanner device. The scanner device may be an independent piece of equipment with an antenna, digital logics, tuner, digital signal processing and etc. The scanner device is a device for measuring the signal strength of the control channel for various wireless technologies. In present embodiment, the plurality of cellular phones utilizing various wireless technologies is used to collect data from the traffic channel during data transfer. In comparison, the scanner device is used to collect data from the control channel. It is appreciated that the wireless test equipment mentioned above are exemplary and are not intended to limit the scope of the invention. In other embodiments, the wireless test equipment may be a computer or other electronic devices capable of transmitting and receiving data. It is further appreciated that the term “initiating a call” throughout this document refers to those situations where a call is initiated but not completed as well as when a call is initiated and completed.

At step 120, the wireless test equipment receives and gathers data for the various wireless technologies in a given cellular structure. It is appreciated that steps 110-120 may be repeated in the given cellular structure in order to obtain a large enough sample, such that the sample can statistically represent the entire cellular structure. It is similarly appreciated that steps 110-120 may be repeated for different cellular structures, such that the sample can statistically represent a plurality of cellular structures.

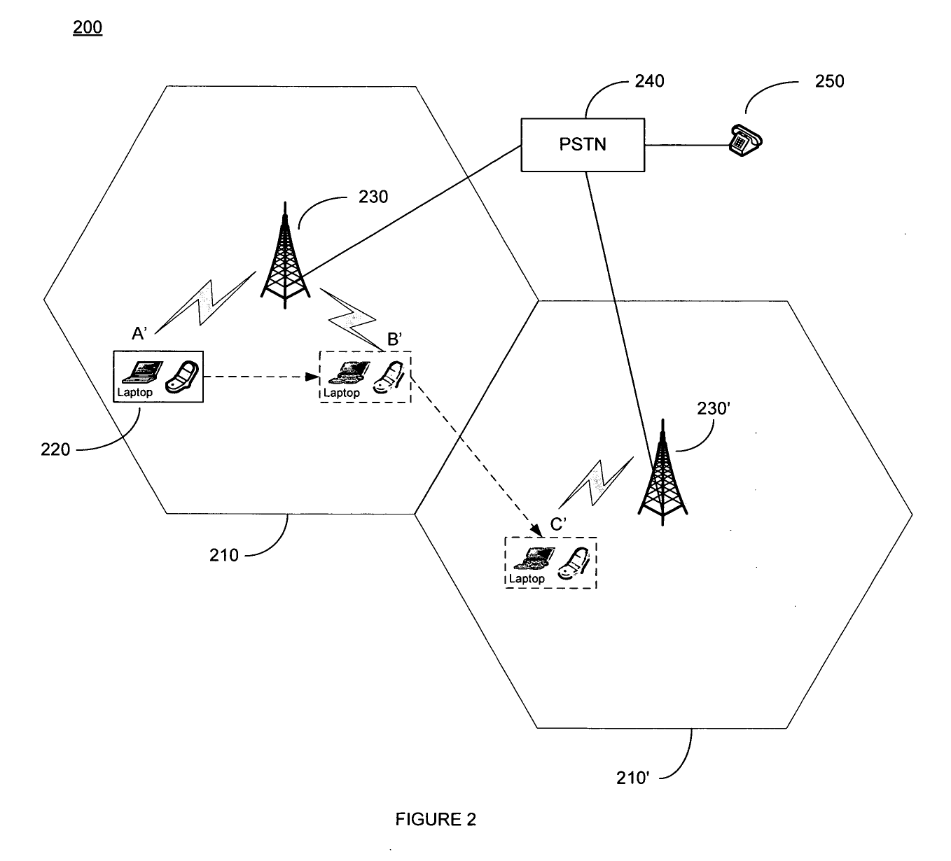

Referring now to FIG. 2, one system 200 embodiment in accordance with the present embodiment for initiating a call and receiving data is shown. System 200 shows two adjoining cellular structures 210 and 210′. It is appreciated that the system may comprise many more cellular structures, however, for simplicity only two adjoining cellular structures 210 and 210′ are shown.

Referring still to FIG. 2, the wireless test equipment comprises a scanner, which is represented as a lap top, and a plurality of cellular phones utilizing different wireless technologies. The wireless test equipment 220 initiates a call at position A′ to a telephone 250. In order to initiate the call, the wireless test equipment 220 communicates with the base station 230 over the control channel. Upon establishing a connection, the wireless test equipment 220 may initiate a data transfer over the traffic channel. The base station may be coupled to a public switching telephone network (PSTN) 240 which may be in turn coupled to the telephone 250. It is appreciated that even though a PSTN is shown, other equivalent structures may be used. It is also appreciated that even though a phone is shown, other electronic devices capable of communicating with the PSTN or equivalent structure may be used instead.

When a call is initiated by the test equipment 220, a plurality of data is received. Data received may include the signal strength and the quality of the signal from the base station 230. It is appreciated that the received data (e.g., signal strength and the quality of the signal) are exemplary and not intended to limit the scope of the present invention. In one embodiment, the received data may be stored for retrieval and further analysis at a later date. Alternatively, the received data may be transferred to other electronic devices for storage or analysis.

It is appreciated that various technologies use different parameters to describe concepts such as error rate, signal strength, signal quality and etc. For example, in a GSM technology these concepts may be described by parameters such as RSSI for signal strength indicator, RxLevel for signal level, RxQuality for signal quality, frame error rate (FER), bit error rate (BER), C/I for signal to noise ratio and etc. In CDMA technology these parameters may include Ec/Io for energy to noiseratio, RSSI, FER and etc. Evolution data optimized (EVDO) technology may described these concepts using parameters such as C/I, signal to noise ratio (SINR), automatic gain control (AGC0 and AGC1 for two signal paths) and etc. High speed download packet access (HSDPA) may describe these concepts using parameters such as received signal code power (RSCP), Ec/No and etc. It is therefore appreciated that the type of parameters used are exemplary and are not to be construed as limiting the scope of the present invention.

The wireless test equipment 220 may then move to another location (e.g., position B′) within the same cellular structure (e.g., cellular structure 210). At the new location (e.g., position B′) the wireless test equipment 220 initiates a call to the telephone 250 and receives the corresponding data for position B′. This process may be repeated through out the cellular structure 210, such that statistically a large enough sample for cellular structure 210 is generated. The process is similarly repeated at other cellular structures (e.g., cellular structure 210′), such that statistically large enough sample for multiple cellular structures are generated (e.g., cellular structure 210 and 210′). For example, at position C′ in cellular structure 210′, the wireless test equipment 220 may initiate a call to the telephone 250. Accordingly, the wireless test equipment 220 communicates with a base station 230′ which is coupled to the PSTN 240 or an equivalent structure, which is in turn coupled to the telephone 250. The wireless test equipment 220 receives a plurality of data at position C′. The process may be repeated in the same cellular structure at different positions as discussed above.

Referring again to FIG. 1, at step 130 the received data is analyzed. In one embodiment, the analyzed data may include the probability of call failure and its corresponding signal strength.

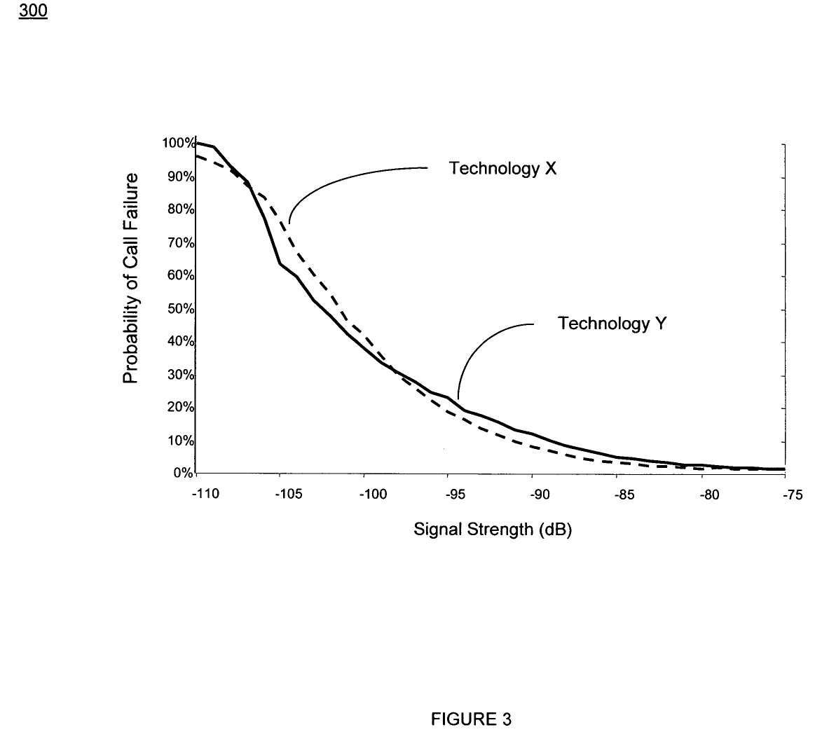

Referring now to FIG. 3, a graphical representation 300 of exemplary analyzed data in accordance with one embodiment of the present invention is shown. In general, signal strength is related to the coverage for a given wireless technology. Accordingly, the signal strength is related to whether a call can be initiated. As such, the signal strength is also related to the probability of call failures.

Referring still to FIG. 3, the signal strength using two different technologies (e.g., technology X and Y) are shown relative to the corresponding probability of call failures. Technology X is represented by a dashed line and Technology Y is represented by a solid line. As expected, the stronger the signal strength the lower the probability of call failure. However, most providers and carriers are interested in comparing the performance of different technologies and the differences in their coverage. In the exemplary FIG. 3, most carriers may be interested in the gap between the two technologies. For example, a carrier using Technology X may be interested in understanding the reason why, despite of using higher signal strength between −98 dB and −107 dB, their technology results in a higher probability of call failure than that of Technology Y, which uses lower signal strength.

Additionally, the analyzed data may be used to create a standard for comparing various technologies. For example, at probability of call failure of 70%, Technology X has a signal strength of −104 dB and Technology Y has a signal strength of −106 dB. Therefore, one may deduce that the signal strength of −104 dB of Technology X is equivalent to the signal strength of −106 dB of Technology Y and have the same coverage. It is appreciated that the graphical representation 300 is exemplary and not intended to limit the scope of the invention.

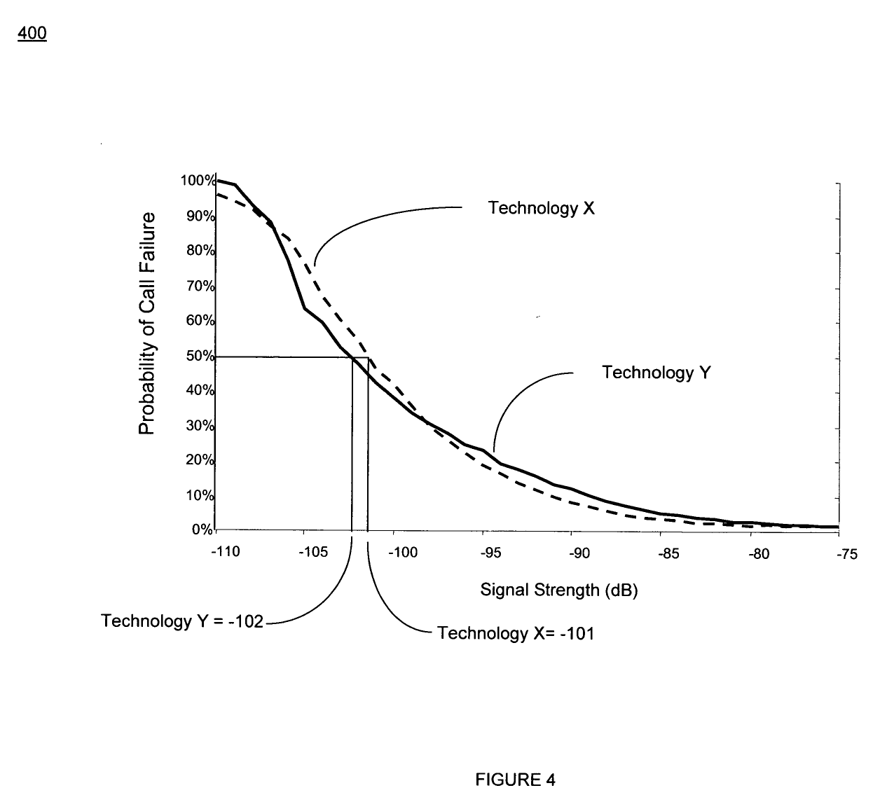

Referring again to FIG. 1, at step 140 a calibration of signal levels for different wireless technologies are generated. Referring now to FIG. 4, a graphical representation 400 of the exemplary calibration of signal levels for different wireless technologies is shown. Similar to above, the two technologies Technology X and Y are compared. In order to calibrate signal levels, signal levels of different technologies at a given probability of call failure are compared. For example, in the graphical representation 400, the signal strength of Technology X and Y are compared at probability of call failure of 50%. Technology X has a signal strength of −101 dB, at probability of call failure of 50%. Technology Y on the other hand has a signal strength of −102 dB, at probability of call failure of 50%. This process may be repeated for various probabilities of call failures in order to generate a calibration of signal levels for different wireless technologies. It is appreciated that the graphical representation 400 is for illustration purposes and not intended to limit the scope of the present invention.

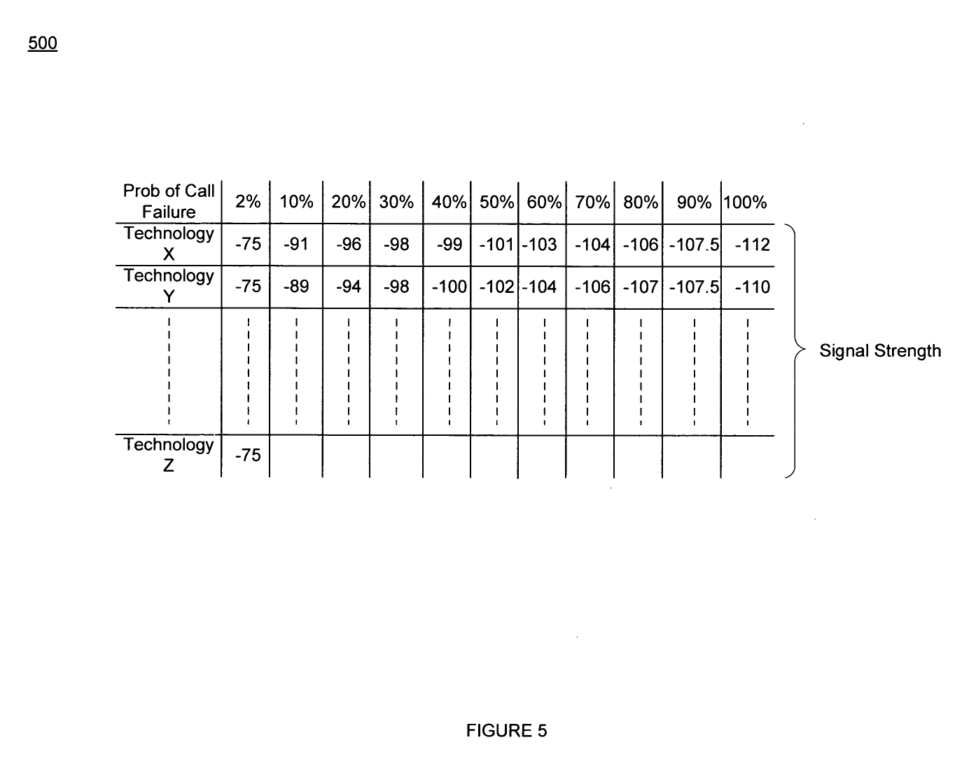

Referring again to FIG. 1, at step 150 adjusted signal metric based on the generated calibration of signal levels is constructed. Referring now to FIG. 5, a tabular representation 500 of the exemplary adjusted signal metric based on the calibration in step 140 is shown. The table 500 shows equivalent signal strengths for various technologies at various probabilities of call failures. For example as discussed above, at probability of call failure of 50% the signal strength for Technology X is −101 dB and the signal strength for Technology Y is −102 dB. Therefore, at signal strength of −101 dB, the coverage of Technology X is equivalent to signal strength −102 dB of Technology Y. Similarly, at signal strength of −91 dB, the coverage of Technology X is equivalent to signal strength −89 dB of Technology Y.

Accordingly, a standard is created such that the coverage of various technologies may be compared. It is appreciated that the representation in tabular form is exemplary and it is not intended to limit the scope of the invention.

Referring again to FIG. 1, at step 160 the constructed adjusted signal metric may be outputted. The output may be to other electronic devices such that the setup parameters for a given technology in a given cellular structure can be changed in order to vary its coverage. In one embodiment, the output may be to a display such as the tabular representation as shown in FIG. 5. In other embodiments, the output may be in an audio format. Furthermore, in one embodiment the output may be printed and presented to the user.

Accordingly, the embodiments of the present invention create a unique standard for comparing the coverage of various wireless technologies. In other words, the embodiments of the present invention create a standard such that the equivalence coverage of various wireless technologies (e.g., signal strength at various probabilities of call failures) can be compared.

It is appreciated that measuring cross technology for wireless device coverage may be extended to data, applications and other technologies. For example, the method and system described above may be extended to a CDMA system comprising CDMA 2000, EVDO Rev0, EVDO Rev A, EVDO Rev B, EVDO Rev C, evolution data and voice (EVDV) and video network (e.g., Forward Link Only (FLO), digital video broadcasting for handheld (DVB-H), DVB-1, digital audio broadcasting (DAB)), to name a few. Moreover, the method and system described above may be extended to a GSM system comprising WCDMA (e.g., enhanced data rate for GSM evolution (EDGE), universal mobile telecommunication system (UMTS), HSDPA and high speed uplink packet access (HSUPA)), FTD and 3 generation partnership project long term evolution (LTE), to name a few. Accordingly, a graphical representation of a calibration signal levels for data/application of various technologies may be generated according to method 100 and as shown in FIGS. 3 and 4.

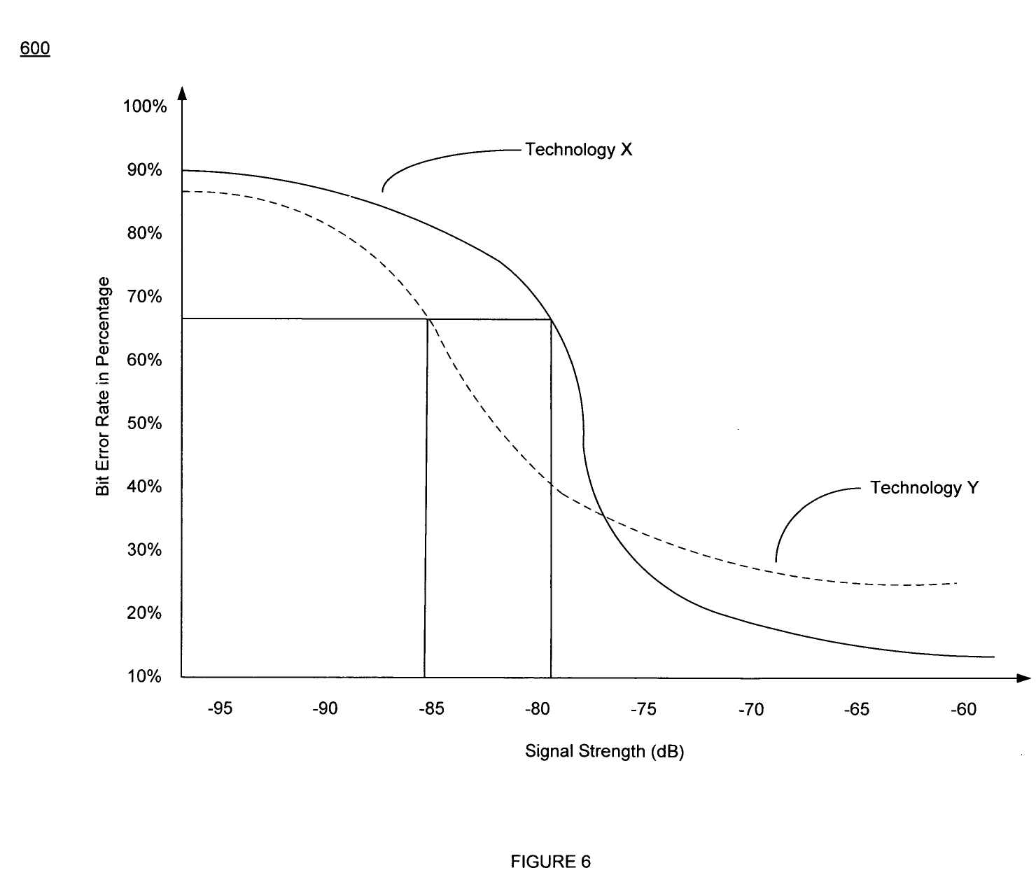

Referring now to FIG. 6, an exemplary graphical representation 600 of a calibration signal levels for data/application of different wireless technologies in accordance with one embodiment of the present invention is shown. As discussed above, signal strength is related to the coverage for a given wireless technology. Accordingly, the signal strength is related to the bit error rate. In general, data/application for wireless devices is more susceptible to signal strength compared to voice data.

The signal strength of data/application using two different technologies (e.g., technology X and Y) are shown relative to the corresponding bit error rates. Technology Y is represented by a dashed line and Technology X is represented by a solid line. As expected, the stronger the signal strength the lower the bit error rate. However, as discussed above, most providers and carriers are interested in comparing the performance of different technologies and the differences in their coverage. For example, most carriers may be interested in the gap between the two technologies. For example, a carrier using Technology X may be interested in understanding the reason why, despite of using higher signal strength between −76 dB and −95 dB, their technology has a higher bit error rate compare to Technology Y, which uses lower signal strength.

Additionally, the analyzed data may be used to create a standard for comparing various technologies. For example, at the bit error rate of 68%, Technology X has signal strength of −80 dB and Technology Y has signal strength of −85 dB. Therefore, one may deduce that the signal strength of −80 dB of Technology X is equivalent to the signal strength of −85 dB of Technology Y and have the same coverage. It is appreciated that the graphical representation 600 is exemplary and it is not intended to limit the scope of the invention.

As discussed above, at step 140 a calibration of signal levels for different wireless technologies are generated. In order to calibrate signal levels, signal levels of different technologies at a given bit error rate are compared. For example, in the graphical representation 600, the signal strength of Technology X and Y are compared at bit error rate of 68%. Technology X has signal strength of −80 dB, at the bit error rate of 68%. Technology Y on the other hand has signal strength of −85 dB, at the bit error rate of 68%. This process may be repeated for various bit error rates in order to generate a calibration signal levels for different wireless technologies implementing data/application.

Similar to FIG. 5 and as discussed above, at step 150 the adjusted signal metric based on the generated calibration signal levels may be constructed (not shown). It is therefore, appreciated that the signal levels may be calibrated for data/application implemented by various technologies. It is appreciated that the calibration as described may be performed for any of the parameters of a given technology described above.

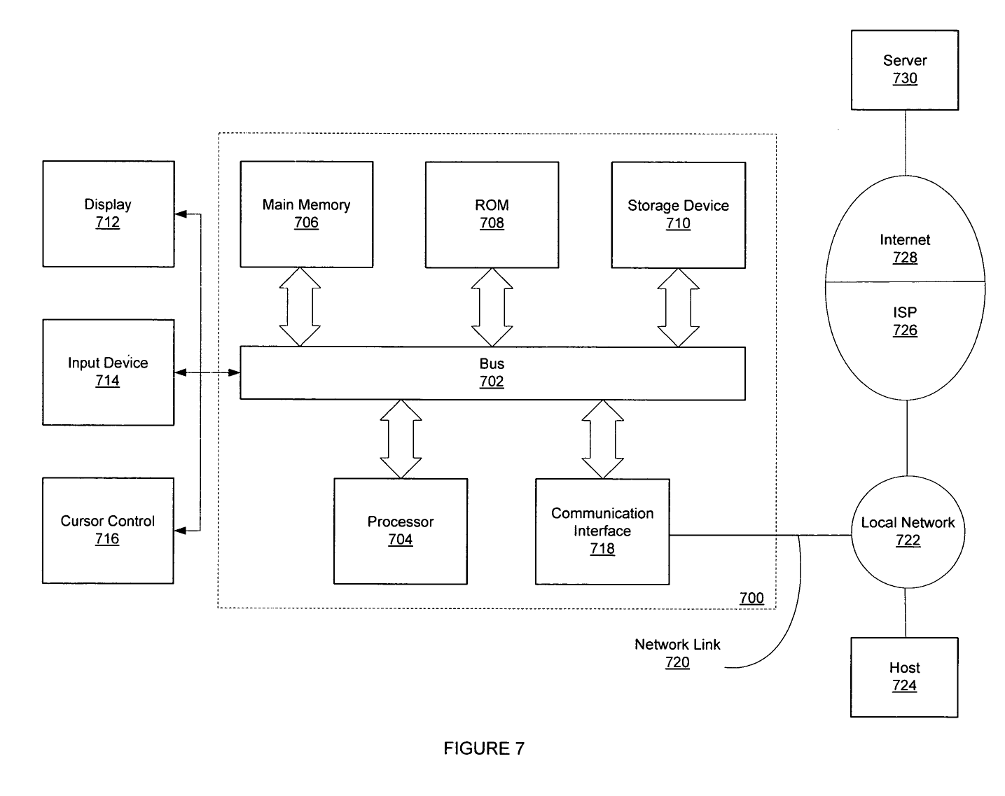

FIG. 7 is a block diagram that illustrates a computer system 700 upon which an embodiment of the invention may be implemented. Computer system 700 may implement the method for measuring cross technology wireless coverage as shown in FIGS. 1-6 and includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A non-volatile storage device 710, such as a magnetic disk or optical disk, is provided and coupled to bus 702 for storing information and instructions and may store the persistent internal queue.

Computer system 700 may be coupled via bus 702 to an optional display 712, such as a cathode ray tube (CRT), for displaying information to a computer user. An optional input device 714, including alphanumeric and other keys, may be coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712.

The invention is related to the use of computer system 700 for measuring cross technology wireless coverage. According to one embodiment of the invention, the interface is used in response to processor 704 executing one or more sequences of one or more instructions contained in main memory 706 e.g., to implement process 100. Such instructions may be read into main memory 706 from another computer readable medium, such as storage device 710. Execution of the sequences of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infrared transmitter to convert the data to an infrared signal. An infrared detector coupled to bus 702 can receive the data carried in the infrared signal and place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of carrier waves transporting the information.

Computer system 700 can send and receive messages through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of measuring cross technology wireless coverage, said method comprising:
a) initiating a call from a wireless device using a given wireless technology;
b) in response to said initiating, receiving a plurality of data for said given wireless technology;
c) in response to said receiving, analyzing said plurality of data;
d) repeating steps (a)-(c) for various wireless technologies; and
e) generating a calibration for said analysis of said plurality of data for various wireless technologies.

2. The method as described in claim 1, further comprising:
f) constructing adjusted data for said plurality of data in response to said generated calibration.

3. The method as described in claim 2, further comprising:
g) outputting said constructed adjusted data.

4. The method as described in claim 3, wherein said constructed adjusted data is visually outputted.

5. The method as described in claim 3, wherein said output is an audio output.

6. The method as described in claim 1, wherein said analyzing comprises:
determining the signal strength for said wireless device of said given wireless technology; and
determining the probability of call failure for said wireless device of said given wireless technology.

7. The method as described in claim 6, wherein said calibration comprises:
at a given probability of call failure, corresponding signal strengths of said wireless device for various wireless technologies to one another.

8. A computer-useable medium having computer-readable program code stored thereon for causing a computer system to execute a method for measuring cross technology wireless coverage, said method comprising:
a) initiating a call from a wireless device using a given wireless technology;
b) in response to said initiating, receiving a plurality of data for said given wireless technology;
c) in response to said receiving, analyzing said plurality of data;
d) repeating steps (a)-(c) for various wireless technologies; and
e) generating a calibration for said analysis of said plurality of data for various wireless technologies.

9. The computer-useable medium as described in claim 8, wherein said method further comprises:
f) constructing adjusted data for said plurality of data in response to said generated calibration.

10. The computer-useable medium as described in claim 9, wherein said method further comprises:
g) outputting said constructed adjusted data.

11. The computer-useable medium as described in claim 10, wherein said constructed adjusted data is visually outputted.

12. The computer-useable medium as described in claim 10, wherein said output is an audio output.

13. The computer-useable medium as described in claim 8, wherein said analyzing comprises:
determining the signal strength for said wireless device of said given wireless technology; and
determining the probability of call failure for said wireless device of said given wireless technology.

14. The computer-useable medium as described in claim 13, wherein said calibration comprises:
at a given probability of call failure, corresponding signal strengths of said wireless device for various wireless technologies to one another.

15. A computer system comprising a processor coupled to a bus, a transmitter/receiver coupled to said bus, and a memory coupled to said bus, wherein said memory comprises instructions that when executed on said processor implement a method for measuring cross technology wireless coverage, said method comprising:
a) initiating a call from a wireless device using a given wireless technology;
b) in response to said initiating, receiving a plurality of data for said given wireless technology;
c) in response to said receiving, analyzing said plurality of data;
d) repeating steps (a)-(c) for various wireless technologies; and
e) generating a calibration for said analysis of said plurality of data for various wireless technologies.

16. The computer system as described in claim 15, wherein said method further comprises:
f) constructing adjusted data for said plurality of data in response to said generated calibration.

17. The computer system as described in claim 16, wherein said method further comprises:
g) outputting said constructed adjusted data.

18. The computer system as described in claim 17, wherein said constructed adjusted data is visually outputted.

19. The computer system as described in claim 17, wherein said output is an audio output.

20. The computer system as described in claim 15, wherein said analyzing comprises:
determining the signal strength for said wireless device of said given wireless technology; and
determining the probability of call failure for said wireless device of said given wireless technology.

21. The computer system as described in claim 20, wherein said calibration comprises:
at a given probability of call failure, corresponding signal strengths of said wireless device for various wireless technologies to one another.
